(19) United States
(12) Patent Application Publication
(10) Pub. No.: US 2011/0187093 A1
(43) Pub. Date: Aug. 4, 2011

(54) NOVELTY NOTES

(76) Inventor: Alan White, Montclair, NJ (US)

(21) Appl. No.: 12/698,868

(22) Filed: Feb. 2, 2010

(51) Int. Cl. B42D 15/00; G06Q 90/00

(52) U.S. Cl. 283/67; 705/500; 283/56

(57) ABSTRACT

A non-counterfeit replica of a real U.S. paper bill and a method of promoting a business with a non-counterfeit replica of a real U.S. paper bill having an obverse side and a reverse side which is oppositely positioned one from the other. A dollar denomination is disposed on the obverse and reverse sides of the non-counterfeit replica of a real U.S. paper bill which is an unavailable amount between $1 and $100,000,000 and contact related information of a provider of the non-counterfeit replica of a real U.S. paper bill is disposed on at least one of the sides of the non-counterfeit replica of a real U.S. paper bill.

### BACKGROUND OF THE INVENTION

1. Field of the Invention

The present invention relates generally to a novelty currency and, more specifically to a novelty currency which is in the form of a dollar denomination bill that is a non-counterfeit United States bill in any unavailable amount such as $3.00, $25.00, $101.00, $757.00, $1009.00, $9000.00, $10,000; $100,000; $100,000,000; etc. The novel currency which appears at first glance to be real contains contact information which normally appears on a business card and is used by the provider as a business card. In another embodiment the novel currency is a business card which is a folded sheet of paper that can be partially opened to provide a tent card and can be used for taking notes. When used as a business card that has the obverse and reverse sides of a non-counterfeit United States bill replica on opposite sides of a single sheet of paper, the unfolded sheet of paper may be larger, smaller or substantially the same size of a real United Stated bill. When used as a card which is a sheet of paper folded in half, the obverse and reverse sides of the non-counterfeit U.S. bill replica are first printed on the same side of the sheet of paper and then folded in half. When opened partially, the non-counterfeit bill replica can become a tent card and, when opened fully can be used for taking notes or used for displaying printed material.

2. Description of Related Art

Business cards are currently used to identify an individual and his/her company and are of a size that can be placed into a wallet. More recently, some business cards now include a photograph or some other identifying feature to further distinguish the provider and identify the provider's company. One type of business card that is different, that can be placed into a person's wallet and which can create an immediate positive impression is a realistic non-counterfeit U.S. bill that is not in an available denomination and which includes contact information about the provider.

The use of various types of non-realistic money is known in the prior art. More specifically, by way of example, U.S. PreGrant Pub. No.: 2004/0174010 to McGuiness discloses a business card which has the normal information, such as name address and telephone number printed on one side of the card and this same information is printed on a static cling sheet which is attached to the opposite side of the card.

U.S. Pat. No. 5,299,835 to Sonnenberg discloses a promotional note page which includes a first page portion having space for writing notes, a second page portion in the form of a business card, and a separation line for separating the first page portion from the second page portion. Letterhead notation along at least one edge of the first page portion is preferably provided. The line of separation is preferably a series of perforations. At least one flap portion may be provided, having a line of separation for separating and/or folding the flap portion from the rest of the note page. The line of separation is preferably a series of perforations. At least one line may be provided on the first portion to guide handwriting thereon. Alternatively, at least one stripe on the first portion to guide handwriting on it may be provided. Another option is at least one tab portion which can be folded over to increase thickness for securing a fastener and for aiding alignment of an attachment.

U.S. Pat. No. 6,179,337 to Zumberge discloses a business card assembly having a standard wallet-sized card with top and bottom surfaces. Business card identification information is printed on the top surface. Two or more adhesive-backed removable labels are secured to the bottom surface of the business card, and each of these labels has the business card identification information printed on it. The labels may be peeled off and placed, for example, in one's personal planner, file, or other convenient location. The card may be a traditional flat style, or a tent style. The card may also include a release liner beneath the removable labels, the release liner also optionally including additional printed information.

U.S. Pat. No. 5,887,899 to Dobbins discloses a card which has a printed face, a back, and a fold line which divides the card into a main portion and a flap which is foldable over the fold line so that the back of the flap is flush with the back of the main portion and the face of the card has the shape and appearance of a conventional business card. An adhesive layer is disposed on the back of the card so that with the flap open the adhesive may be exposed and the card removably adhered to a smooth vertical surface, juxtaposing the face of the flap and an auxiliary message printed upon the same with the face of the main portion. Removal of the card from the surface and either folding of the flap or separation of the same from the main portion converts the card back to one which has a face that has the shape and appearance of a conventional business card.

U.S. Pat. No. 4,658,125 to Kachi, et al. discloses a gift coupon that is detectable by a bill sorter, comprising a rectangular paper having a width capable of being inserted into a travelling path of the bill sorter and also having predetermined characters and design, the gift coupon further having: a first data train comprising data units formed by a magnetic ink and arranged in a row at predetermined intervals, and a second data train comprising data units corresponding respectively to the data units of the first data train, formed by a magnetic ink and arranged in a row, data units in predetermined positions of the second data train being cut off to provide blank units to record data required for the gift coupon such as the significance of an amount of money, the name of commodity to be exchanged, etc. according to the arrangement of the blank units, the first and second data trains being disposed in positions capable of being detected by two magnetic detection heads for bill sorting provided in the bill sorter during travel of the gift coupon along the travelling path.

U.S. Pat. No. 4,139,219 to Herndon discloses a system for marking money to permit stolen money to be traced to its source in which each bill received by a business is stamped with a two part code including a date and a business identification number whereby, upon a theft, the date and identifying number can be distributed permitting others receiving the money to identify it as being stolen.

U.S. Pat. No. 5,429,373 to Chelko, et al. discloses play money to be earned and spent by children comprising a plurality of sheets of bills of money of various numerical denominations, the money having printed thereon the denominations, a happy child face and “money” printed thereon, such money adapted to be earned by children as a reward for activities and for spending or playing video games; and a pouch having a front face and a rear face, each face fabricated in a rectangular configuration and coupled together along side edges and bottom edges leaving an open top edge for the passage of money, the pouch having a flap to close the top edge with a releasable fastener associated with respect thereto, the pouch having printed thereon “money” and a space for receipt of a child's name.

U.S. Pat. No. 5,442,162 to Armel discloses an improved traveler's check issuable by a number of different institutions and substantially uniform in appearance. The traveler's check identifies on its face the individual customer to whom the check is issued. The individual identifying information includes a representation of the individual's portrait and signature and an account number, and appears on each traveler's check in a predetermined form and area. A system for issuing the improved traveler's checks includes: an identification imaging apparatus for recording the representation of the customer's portrait and signature, a central computer for storing recorded representations and customer account data, and a traveler's check dispenser through which checks may be issued upon proper request.

### SUMMARY OF THE INVENTION

In an exemplary embodiment of the present invention, there is disclosed a non-counterfeit replica of a real U.S. paper bill having an obverse side and a reverse side which are oppositely positioned one from the other. A dollar denomination is disposed on the obverse and reverse sides of the non-counterfeit replica of a real U.S. paper bill which is an unavailable amount between $1 and $100,000,000 and contact related information of a provider of the non-counterfeit replica of a real U.S. paper bill is disposed on at least one of the sides of the non-counterfeit replica of a real U.S. paper bill.

In another exemplary embodiment of the present invention, there is disclosed a method of promoting a business with a non-counterfeit replica of a real U.S. paper bill having an obverse side and a reverse side which are oppositely positioned one from the other. A dollar denomination is disposed on the obverse and reverse sides of the non-counterfeit replica of a real U.S. paper bill which is an unavailable amount between $1 and $100,000,000 and contact related information of a provider of the non-counterfeit replica of a real U.S. paper bill is disposed on at least one of the sides of the non-counterfeit replica of a real U.S. paper bill.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a view of the obverse side of a U.S. paper bill;

FIG. 2 is a view of the reverse side of the U.S. paper bill of FIG. 1;

FIG. 3 is a view of the obverse side of non-counterfeit realistic appearing U.S. bill of an unavailable denomination in accordance with the principles of the invention;

FIG. 4 is a view of the reverse side of non-counterfeit realistic appearing U.S. bill of an unavailable denomination in accordance with the principles of the invention; and

FIG. 5 is a view of the obverse side and reverse side of non-counterfeit realistic appearing U.S. bill of an unavailable denomination on the same side of a sheet of paper prior to being folded in half in accordance with the principles of the invention.

### DESCRIPTION OF THE PREFERRED EMBODIMENT

Business cards are used by individuals during social and business meetings as a method of providing contact information about themselves to a recently met individual. The card is normally used during a formal introduction, an informal meeting and at a business meeting as a convenient method of providing to the receiver of the card relative information about the provider. A business card will typically include the provider's name, his/her title, the name of the provider's company, and other contact information such as street address, telephone number, facsimile number, cell phone number, email address and possibly the company website. A traditional business card is normally two inches by three and one-half inches and the information is printed in black ink on one side of the card. Fold-over or tent cards which fold to the standard size card are occasionally used.

After receiving a business card, the person will normally place it into his/her wallet along with other business cards where it can become a forgotten item.

The invention here disclosed is a business card which, at first glance, appears as U.S. currency. Upon closer inspection the receiver will realize that the item is the provider's business card in the form of a non-counterfeit dollar denomination bill replica that is in a non-available amount such as a three dollar bill, a nineteen dollar bill, a one hundred million dollar bill in any denomination from a twenty five cents bill up to and including a limitless amount such as an infinity symbol. In one embodiment, the provider's business card is a non-counterfeit realistic appearing U.S. bill of an unavailable denomination which is printed on both sides of a single sheet of paper. In another embodiment, the business card is a non-counterfeit realistic appearing U.S. bill of an unavailable denomination which is printed on the same side of a single sheet of paper which had been folded in half to provide a card which, when partially unfolded can become a tent card and, when fully opened can be used to display printed matter or used for taking notes.

The non-counterfeit realistic appearing U.S. bill of an unavailable denomination can be larger, smaller or have substantially the same dimensions of a real U.S. denomination bill.

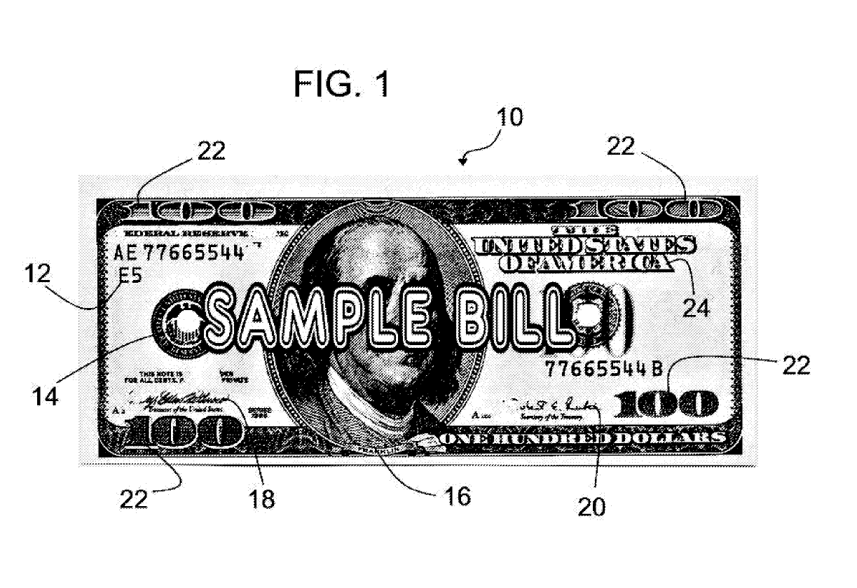

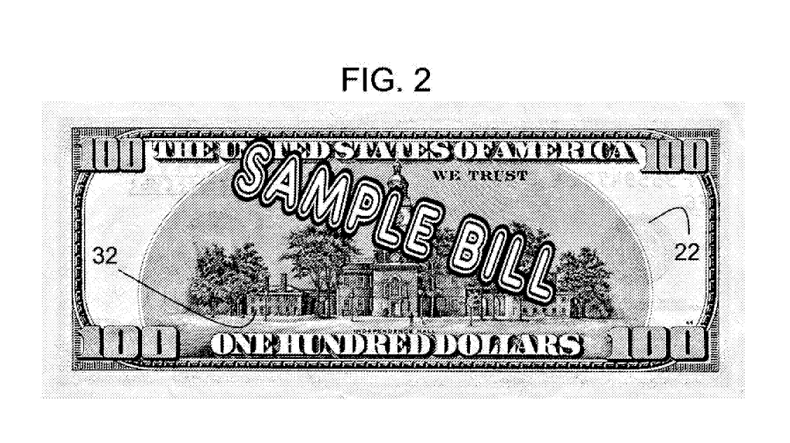

Referring to FIGS. 1 and 2, there is shown the obverse and reverse sides of a real $100 bill. In FIG. 1, the obverse side of the real bill 10 displays a serial number 12, a seal showing a picture of an eagle 14, the picture of a president of the United states 16, the signature of the Treasurer of the United States 18, the signature of the Secretary of the Treasury 20 and, in four places, 22, the dollar value of the bill. At location 24 the “United States of America” is clearly identified.

Looking at FIG. 2, the reverse side 30 of the real bill prominently displays a picture of Independence Hall 32, a cluster of trees and the denomination of the bill in numbers and letters.

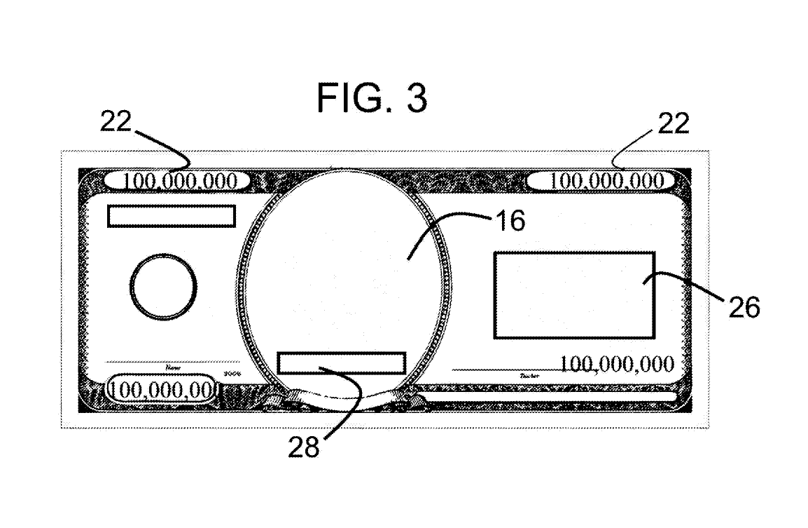

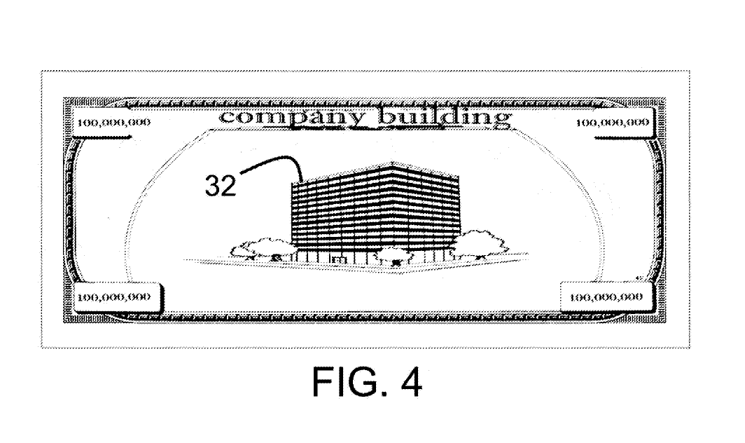

Looking at FIG. 3, there is shown the obverse side of a non-counterfeit replica of the $100 bill of FIG. 1 modified to be a business card by displaying the provider's contact information on a single sheet of paper. In place of the $100 value at 20, a value of $100,000,000 is inserted. The picture of the president, 16, is changed to be a picture of the provider of the business card. The provider's address, telephone number, facsimile number, cell phone number and email number can be located in block 26. The provider's name and title can be located immediately below the provider's picture in block 28. To help provide realism to the non-counterfeit bill replica, the dollar value of $100,000,000 should appear on the reverse side 30, (FIG. 4), of the bill. If desired, in place of the building 32, a picture of the company building can be provided. It is understood that the picture which is printed on the non-counterfeit bill replica can be any picture such as a picture of an author, a historical figure, an animal, etc.; and the information can be a word or group of words which relate to any subject, real or fictional. It is also understood that the non counterfeit bill replica is not reprinted to any specific type of item but can be promotional printed matter such as coupons, brochures, flyers, etc.

The color of the ink, the general layout and the design on the reverse side of the non-counterfeit replica should replicate as close as possible the reverse side of an actual bill.

A quick first glance at the modified non-counterfeit replica of the bill by a person who first receives the bill will create the immediate illusion that the bill is real. However, after a few seconds the receiver of will realize that the non-counterfeit bill replica is not real and is actually the provider's business card with all the provider's contact information and an identifying picture of the provider.

It is believed that the presentation of the novel card with the provider's contact information will leave a lasting and favorable impression on the receiver and possibly result in the beginning of friendly business relationship.

In another embodiment, the non-counterfeit bill replica shown in FIGS. 3 and 4 can be used as a business card or promotional material in the form of a tent card and/or as a card for taking notes. In this embodiment the obverse and reverse sides of the non-counterfeit bill replica are printed on the same side of a single sheet of paper, and the sheet of paper is then folded in half to show the obverse side of the bill on one side of the fold and the reverse side of the bill on the other side of the fold. When folded, the non-counterfeit replica of a bill can have the dimension of real U.S. bill and the inside of the folded non-counterfeit bill replica can be used for displaying a printed message or for the receiver to write on.

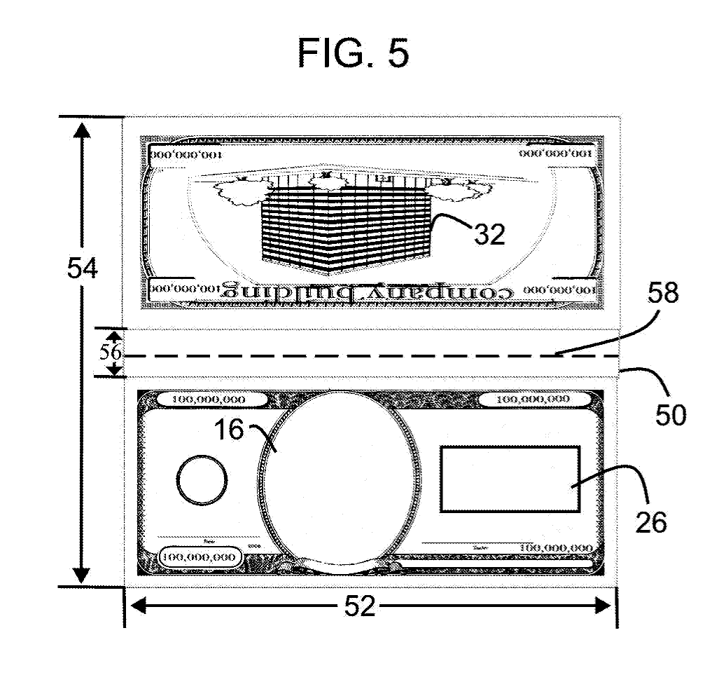

Referring to FIG. 5, a single sheet of paper 50 is shown that has a length 52 that can be larger, smaller or substantially equal to the length of a standard U.S. bill and a height 54 that can be larger, smaller or substantially equal to twice the height of a real U.S. bill plus about one-half of an inch, 56, more or less. The obverse side of the non-counterfeit bill replica is printed right side up on the bottom half of the sheet of paper, and the reverse side of the non-counterfeit bill replica is printed up side down on the top half of the sheet of paper. The sheet of paper is then folded on fold line 58 which is located along the center of the paper between the obverse and reverse sides of the bill.

In use, when paper 50 is folded along fold line 58, the non-counterfeit replica of the $100,000,000 bill will appear as a $100,000,000 bill. Upon close examination the receiver of the non-counterfeit replica of the bill will quickly realize that it is the provider's card or promotional material and that it can be opened up to provide a blank sheet of paper which can be used for taking notes. In addition, the receiver of the non-counterfeit replica of the $100.000.000 bill will also realize that is can be partially opened to become a tent card.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A non-counterfeit replica of a real U.S. paper bill comprising:
an obverse side and a reverse side;
said sides oppositely positioned one from the other;
a dollar denomination disposed on said obverse and reverse sides of said non-counterfeit replica of a real U.S. paper bill that is an unavailable amount; and
contact related information of a provider of the non-counterfeit replica of a real U.S. paper bill disposed on at least one of the sides of said non-counterfeit replica of a real U.S. paper bill.

2. The non-counterfeit replica of a real U.S. paper bill of claim 1 wherein said contact information is disposed on said obverse side.

3. The non-counterfeit replica of a real U.S. paper bill of claim 1 wherein said contact information is disposed on said reverse side.

4. The non-counterfeit replica of a real U.S. paper bill of claim 1 wherein said contact information is disposed on said obverse side and said reverse side.

5. The non-counterfeit replica of a real U.S. paper bill of claim 1 wherein said contact information is business related.

6. The non-counterfeit replica of a real U.S. paper bill of claim 5 wherein said business related information is disposed on said obverse side.

7. The non-counterfeit replica of a real U.S. paper bill of claim 5 wherein said business related information is disposed on said reverse side.

8. The non-counterfeit replica of a real U.S. paper bill of claim 5 wherein said business related information is disposed on said obverse side and said reverse side.

9. The non-counterfeit replica of a real U.S. paper bill of claim 1 wherein said denomination is an unavailable amount from twenty-five cents up to and including infinity.

10. The non-counterfeit replica of a real U.S. paper bill of claim 9 wherein said dollar denomination of an unavailable amount is between $1.25 and less than infinity.

11. The non-counterfeit replica of a real U.S. paper bill of claim 9 further comprising a picture of an individual disposed on the obverse side wherein said picture is of a provider of the non-counterfeit replica of a real U.S. paper bill.

12. A method of promoting a business with a non-counterfeit replica of a real U.S. paper bill comprises:
an obverse side and a reverse side;
said sides oppositely positioned one from the other;
a dollar denomination disposed on said obverse and reverse sides of said non-counterfeit replica of a real U.S. paper bill that is an unavailable amount; and
contact related information of a provider of the non-counterfeit replica of a real U.S. paper bill disposed on at least one of the sides of said non-counterfeit replica of a real U.S. paper bill.

13. The method of promoting a business with a non-counterfeit replica of a real U.S. paper bill of claim 12 wherein said contact information is disposed on said obverse side.

14. The method of promoting a business with a non-counterfeit replica of a real U.S. paper bill of claim 12 wherein said contact information is disposed on said reverse side.

15. The method of promoting a business with a non-counterfeit replica of a real U.S. paper bill of claim 12 wherein said contact information is business related.

16. The method of promoting a business with a non-counterfeit replica of a real U.S. paper bill of claim 15 wherein said business related information is disposed on said obverse side.

17. The method of promoting a business with a non-counterfeit replica of a real U.S. paper bill of claim 15 wherein said business related information is disposed on said reverse side.

18. The method of promoting a business with a non-counterfeit replica of a real U.S. paper bill of claim 12 wherein said dollar denomination is an unavailable amount.

19. The method of promoting a business with a non-counterfeit replica of a real U.S. paper bill of claim 18 wherein said dollar denomination of an unavailable amount is between $1 and $100,000,000.

20. The method of promoting a business with a non-counterfeit replica of a real U.S. paper bill of claim 18 further comprises a picture of an individual disposed on the obverse side wherein said picture is of a provider of the non-counterfeit replica of a real U.S. paper bill.
